(19) United States
(12) Patent Application Publication
(10) Pub. No.: US 2009/0041083 A1
(43) Pub. Date: Feb. 12, 2009

(54) Temperature sensitive, color changing pharmaceutical bottle cap

(76) Inventor: Beverly McParland, Oakhurst, NJ (US)

Correspondence Address: Charles I. Brodsky, 2 Bucks Lane, Marlboro, NJ, 07746-0367, US

(21) Appl. No.: 12/215,162

(22) Filed: Jun. 26, 2008

Related U.S. Application Data
(60) Provisional application No. 60/963,489, filed on Aug. 6, 2007.

(51) Int. Cl. G01K 11/12

(52) U.S. Cl. 374/162; 374/E11.018

(57) ABSTRACT

Temperature-sensitive, color-changing inks, paints and resin concentrate additives are mixed into a child-resistant cap or lid to produce color changes indicative of its bottle having been recently opened and the medication within having been previously taken.

### CROSS-REFERENCE TO RELATED APPLICATIONS

A Provisional Patent Application covering the invention described herein was filed Aug. 6, 2007, and assigned Ser. No. 60/963,489.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to pharmaceutical bottles, in general, and, to pharmaceutical bottles having child-resistant caps or lids, in particular. As will become clear from the following descriptions, the teachings of the invention retain the “push-down and turn” operation of the child resistant cap or lid, but adds the further feature of giving an indication that the bottle has recently been opened and its contents probably been taken.

2. Description of the Related Art

As is well known and understood, the most common way of taking medicine is orally by mouth. The medicine is swallowed and then passes from the stomach or intestine into the blood stream where it is carried to all parts of the body. The speed at which this happens depends upon several factors, including the form in which the medication is given (e.g. syrup or tablet), whether the medicine is taken with food, after food or on an empty stomach, the ability of the medicine to pass into the blood vessels, how the medicine reacts with the acidic conditions in the stomach and alkaline conditions of the upper intestine, and whether the medicine interacts with other medicines given orally.

As is also well understood, various “tips” have been developed over the years for the taking of one's medicine. Inclusive of these are: always reading the instructions carefully, measuring the medicine carefully, taking the medication at the recommended intervals and recommended time, following the instructions, not chewing, crushing or breaking tablets or capsules, not stopping taking the medicine, and completing the course of the prescribed medicine.

All of this is well and good, but not always followed. Thus, over time, there have been designed various types of simple pill reminders—pill box timers and alarms, alarm watches with vibration and/or sound alarms, and automatic pill dispensers. Simply stated, these are but methods and systems designed for reminding and controlling the taking of prescribed medications, and which are particularly useful for the elderly as well as the physically and/or mentally impaired patient. Essentially, they are little more than reminder clocks for initiating an alarm or providing some other form of sensible reminder or alerting indication at preselected times of the day.

However, one of the most common problems associated with this periodic taking of medication by the elderly, and by the physically and/or mentally impaired person, is that the person still simply forgets to take the pill when the appropriate time comes. Sometimes they forget when the last pill was taken, and sometimes they forget that the pill was indeed taken the last time.

As has been noted, many medications are given in maximum safe dosages. Exceeding those dosages by taking pills too often, such as when one forgets when the last pill was taken or if the last pill was taken too late and another pill too soon, may lead to serious consequences. For example, failure to take sufficient pills due to failure to remember when they were last taken, or failure to remember to take a pill at an appointed time (or because some other distraction leads to an interruption of a regimen) may reduce the body level of the medication to an ineffective amount. Later takings of the same drugs, or doubling up of them, may not be advisable, even if the prescribed regimens of medication are closely followed later on.

However, those persons of middle age, those persons on a faster life pace, those who take fewer pills than do the elderly and infirm, those not really attuned to taking medications, and those taking medications only on a temporary basis and not chronically, generally do not use trays to separate the medication by days of the week, or by the hours of the day, or by investing in alarm watches—and certainly do not wait around for automatic pill dispensers to open their drawers to present the tablets, capsules or caplets at their programmed intervals. Those “on the go” have been noted to be so busy as not to remember which of several medications they have taken, or which they typically take with them from place to place. Illustrative of such situations is that typified in the recent “Spiderman 3” movie, where the Editor of the “Daily Bugle” newspaper is constantly being reminded by his secretary as to which medication he had forgotten to take at its prescribed time.

### SUMMARY OF THE INVENTION

Pharmaceutical bottles with injection-molded child-proof safety caps have been around for many years. Even for those people who do not suffer from physical and/or mental impairments, there are still tremendous numbers of instances in which the person may forget whether a pill, tablet, capsule or caplet from pharmaceutical Bottle No. 1 was taken, while opening Bottles No. 2, 3 or 4 for the taking of additional medication. Knowing, for example, that all four medications need to be taken at the same time, one after the other—opening and removing one from Bottle No. 1 and then swallowing it, then opening and removing a second from Bottle No. 2 and then swallowing it, then opening and removing a third from Bottle No. 3 and then swallowing it, instances of forgetfulness occur upon reaching for Bottle No. 4. Specifically, was the pill from Bottle No. 1, 2 and 3 in fact taken?

In accordance with the present invention, this is eliminated through the employment of plastics in the injection-molded bottle cap that change color with temperature. That is, as will be understood, all plastics contain pigments or dyes to make them colored. Just as different chemicals are used to provide different colors, other chemicals can be used to color the plastic and give to it a special property causing it to change color when the temperature changes. Much research in the field is ongoing at the present time in Finland, where plastics have been developed that lose their color at different temperatures. This usually follows from composing the plastic of different types of polymers that can repel each other, automatically assembling into alternating layers. The layer structure then changes with temperature, causing the plastics to reflect light differently, and at different wavelengths.

As will also be understood, temperature-sensitive, color-changing inks, paints and resin concentrates are known in the United States for combining with such plastics as polyvinylchloride and with polyethylene to provide colors which appear with cold and disappear with heat, and colors which change from dark to light as heat increases.

### DETAILED DESCRIPTION OF THE INVENTION

A variety of temperature-sensitive, color-changing inks, paints and resin additives are available from Matsui International Company, Inc., of Gardena, Calif., for example. They vary depending upon what temperature it is desired a particular color to appear below and at what temperature it is desired a color to disappear above. At the present time, available formulations extend from one at which colors appear below —13.0° F. to disappear at temperatures above 5.0° F., to colors which appear at temperatures below 127.4° F. only to disappear at temperatures above 149.0° F. Recognizing that women typically have cooler hands and children have hotter hands, a preferred embodiment of the invention for a child-proof bottle would be one where a color change appears in its cap or lid at temperatures in the range of 86° F. and 91° F. One such additive from Matsui International Company, Inc. is its Type 25, in which color disappears at temperatures above 87.8° F. Although a change from a color “white” to a color “red” may be an optimum realization that the bottle cap or lid has been recently handled and opened, any acceptable color change of this nature would be advantageous once a user is instructed as to the color change meaning. Thus, while the teachings of the invention would appear with a disappearance of a quiescent color, an understanding of the recent grasping and opening of the cap or lid would equally follow as well from a color change with heat from a darker to a lighter color.

One such change now available with the Matsui Type 25 product is from a standard “cold” color brown to a standard “hot” color yellow. Generally available in a concentrate composition of some 20% temperature-sensitive, color-changing ink in a polyvinylchloride resin of 42% with a plasticizer of 38% by weight, other percentages may be utilized for color change once the cap or lid is grasped and held for as little as 10-15 seconds. Such color change remains for several minutes after the cap or lid is twisted back on the bottle, to allow recognition that the bottle has been opened, and presumably that the medication has been taken.

As plastic child-resistant polyethylene and polyvinylchloride caps generally come with a universal picture on the top directing a user to push down and twist the cap to open the container, all that would be necessary, according to the invention, would be the instruction as to what the meaning of a color change in the cap is. In this respect, therefore, the elderly, the physically and/or mentally impaired person and those “on the go” are illustratively advised as to whether the bottle had been recently opened, simply by noting the color of its cap or lid.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the scope of the invention.

I claim:

1. In a pharmaceutical bottle:
a push-down-and-twist-to-open cap or lid of injection molded plastic composition with a temperature sensitive, color-changing ink, paint or resin concentrate additive.

2. The cap or lid of claim 1 wherein the ink, paint or resin concentrate additive changes the coloring of the cap or lid at temperatures in excess of 86° F.

3. The cap or lid of claim 2 wherein the ink, paint or resin concentrate additive changes the coloring of the cap or lid when grasped by the hand.

4. The cap or lid of claim 3 wherein the ink, paint or resin concentrate additive changes the coloring of the cap or lid when grasped by the hand for at least 10 seconds.

5. The cap or lid of claim 3 wherein the ink, paint or resin concentrate additive changes from a darker coloring to a lighter coloring when the cap or lid is grasped by the hand for at least 10 seconds.

6. The cap or lid of claim 3 wherein the ink, paint or resin concentrate additive changes from one color to a second color when the cap or lid is grasped by the hand for at least 10 seconds.

7. The cap or lid of claim 3 in which said cap or lid is of an injection molded polyethylene composition.

8. The cap or lid of claim 3 in which said cap or lid is of an injection molded polyvinylchloride composition.
